(19) United States
(12) Patent Application Publication
(10) Pub. No.: US 2003/0050812 A1
(43) Pub. Date: Mar. 13, 2003

(54) Electronic project management system using project phases

(75) Inventors: P. Hamilton Clark III, Rochester, NY (US); Joel S. Cornell, Pittsford, NY (US); Kathy Cupo, Pittsford, NY (US); William Kane, Pittsford, NY (US); Patricia A. Lauria, Webster, NY (US); Janice L. Malaszenko, Fairport, NY (US); Audrey T. Pantas, Webster, NY (US); J. Ted Potter, Penfield, NY (US)

Correspondence Address: Gunnar G. Leinberg, Esq., Nixon Peabody LLP,, Clinton Square, P.O. Box 31051, Rochester, NY, 14603-1051, US

(73) Assignee: Xerox Corporation

(21) Appl. No.: 09/950,087

(22) Filed: Sep. 10, 2001

(51) Int. Cl. G06F 17/60

(52) U.S. Cl. 705/7

(57) ABSTRACT

System for electronically managing a project. The system includes subsystems for identifying one or more project requirements, creating a project strategy, defining a schedule based upon the project strategy, identifying and obtaining one or more project phases within the project, integrating the one or more phases with the time schedule, identifying which of one or more stored exit criteria are applicable to at least one of the phases of the project, establishing the identified one or more stored exit criteria for the at least one phase, determining whether each of the identified one or more stored exit criteria have been satisfied for the at least one phase, and implementing the project by enabling the project to advance to a next one of the phases based on the determination of whether each of the identified one or more stored exit criteria have been satisfied for the at least one phase.

### FIELD OF THE INVENTION

This invention relates generally to project management and, more particularly, to a method and system for managing projects electronically using project phases.

### BACKGROUND OF THE INVENTION

Project management has become increasingly important because of the reported successes in industry and because it facilitates business process design. Project management is a discipline that studies the coordination, communication and control of organizational processes. An organizational process contains the set of activities involved in handling an arbitrary number of similar cases, which typically stretches across departmental and organizational boundaries.

Project management includes overseeing the design, marketing, profit forecasting, manufacturing and delivery of a particular product or service on a targeted date. Exemplary project management systems take a divide and conquer approach by separating the project management into various project stages that are keyed to discrete time segments. The various stages span from a design stage to an implementation phase. These systems provide structure and guidance for managing a project, but often do not ensure timely or profitable completion. Also, since a myriad of information must be collated, organized and analyzed by a number of persons playing different roles within an organization on an ongoing basis throughout the life of the project, the task of performing project management has been somewhat amorphous and difficult.

Further, these systems typically entail a manually intensive development methodology, requiring formal classroom training and long lead times to create, modify and implement. Attempts have been made to facilitate the above-described systems, but nevertheless the systems remain inadequate since they often utilize a finite amount of historical information or knowledge for cross team learning, and stored data among different development teams has been inconsistent, incomplete or outdated. Further, the systems often focus on building and tracking progress against often inflexible, obsolete time schedules.

### SUMMARY OF THE INVENTION

A method and a computer readable medium having stored thereon instructions for managing a project in accordance with the present invention include obtaining at least one phase for the project, identifying which of one or more stored exit criteria are applicable to at least one of the phases of the project, establishing the identified one or more stored exit criteria for the at least one phase, determining whether each of the identified one or more stored exit criteria have been satisfied for the at least one phase, and enabling the project to advance to a next one of the phases based on the determination of whether each of the identified one or more stored exit criteria have been satisfied for the at least one phase.

A system for managing a project management in accordance with the present invention includes an interface system that obtains at least one phase for the project, an identification system that identifies which of one or more stored exit criteria are applicable to at least one of the phases of the project, a phase establishing system that establishes the identified one or more stored exit criteria for the at least one phase, a determination system that determines whether each of the identified one or more stored exit criteria have been satisfied for the at least one phase, and an advancement system that enables the project to advance to a next one of the phases based on the determination of whether each of the identified one or more stored exit criteria have been satisfied for the at least one phase.

The present invention provides a number of advantages, including integrating organizational knowledge into a real time tool that guides program teams through a complex work flow process while capturing lessons that can be applied to a subsequent project phase. In addition, the present invention provides at least one tool and knowledge regarding critical success factors required at each phase of a project. Still further, the present invention organizes data in a way that can easily be used by program teams, assessors and others. Another advantage of the present invention includes improved product delivery, speed and flexibility.

### BRIEF DESCRIPTION OF THE DRAWINGS

FIG. 1 is a diagram of a system for managing a project in accordance with one embodiment;

FIG. 2 is a block diagram of a project server used in a system for managing a project;

FIG. 3 is a flow chart of a process for managing a project applying time to market principles in accordance with another embodiment;

FIG. 4 is a screen shot of an exemplary Web page illustrating an exemplary home page used for project management;

FIG. 5 is a screen shot of an exemplary Web page illustrating a set of project phases for an exemplary project; and

FIG. 6 is a flow chart of a process for managing a project using exit criteria in accordance with yet another embodiment.

### DETAILED DESCRIPTION OF THE INVENTION

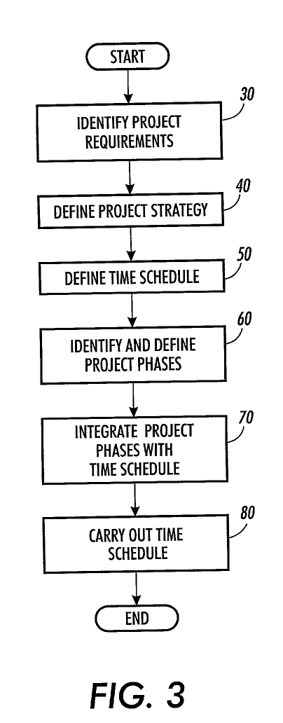

A method for managing a project in accordance with one embodiment of the present invention is illustrated in FIGS. 3-6. The method includes obtaining at least one phase for the project, identifying which of one or more stored exit criteria are applicable to at least one of the phases of the project, establishing the identified one or more stored exit criteria for the at least one phase, determining whether each of the identified one or more stored exit criteria have been satisfied for the at least one phase, and enabling the project to advance to a next one of the phases based on the determination of whether each of the identified one or more stored exit criteria have been satisfied for the at least one phase. The present invention provides a number of advantages, including integrating organizational knowledge into a real time tool that guides program teams through a complex work flow process while capturing lessons that can be applied to a subsequent project phase.

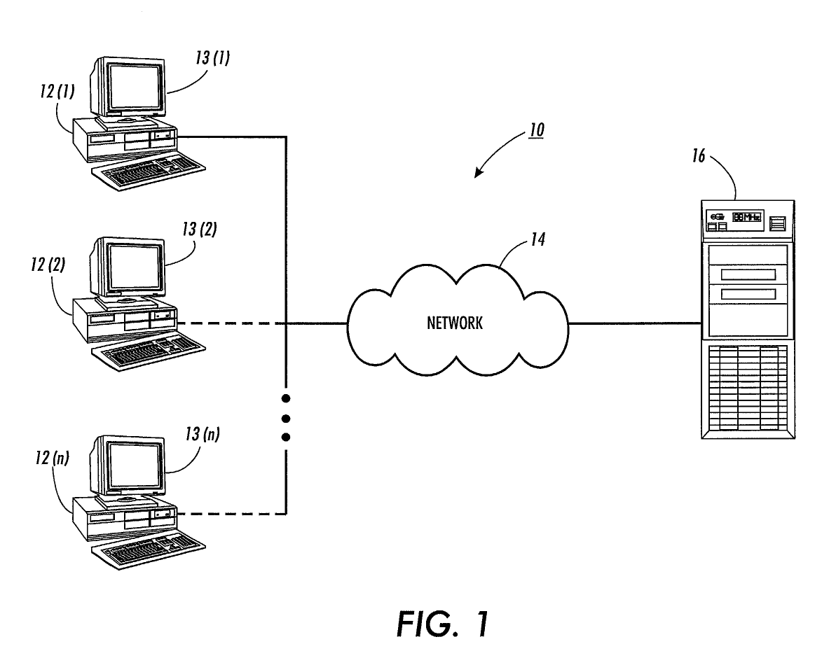

Referring to FIG. 1, a system 10 for managing a project in accordance with one embodiment of the present invention is illustrated. In this particular embodiment, the system includes a plurality of personal computers 12(1)-12(n) coupled to a project server 16 via a network 14, although the system 10 can comprise other types and numbers of systems as needed for the particular application.

In this particular embodiment, each personal computer 12(1)-12(n) comprises one or more processors (not illustrated), one or more memory storage devices (not illustrated) one or more input/output devices (not illustrated), including communication devices such as modems (not illustrated), a display device 13(1)-13(n), such as a conventional color or monochrome computer monitor, and one or more user input devices, such as a mouse, keyboard, light-pen and/or a track-ball (not illustrated). Since the components of a personal computer and their operation are well known, they will not be described in detail herein. Each of the personal computers 12(1)-12(n) may utilize one or more types of operating systems including, for example, Linux®, Windows®, MacIntosh®, UNIX®, SunOS®, and equivalents thereof. Additionally, each of the personal computers 12(1)-12(n) may use conventionally known e-mail applications to generate, send, receive or display e-mail messages, including Microsoft Outlook®, Eudora® or AOL®, for example. Further, each of the personal computers 12(1)12(n) may retrieve, load and display Web pages using conventionally known Web browsers such as Microsoft's Internet Explorer®, Netscape® or AOL®, for example. Although in this particular embodiment, personal computers 12(1)-12(n) are shown, other types of systems, such as a lap-top computer, work station, palm-top computer, Internet-ready/digital mobile telephone, dumb terminal or any other larger or smaller processing system, can be used.

In this particular embodiment, the personal computers 12(1)-12(n) may be coupled to each other to form a local area network (“LAN”), such as an Ethernet®, developed by the assignee of the present application. In this example, the LAN would use one or more protocols, such as TCP/IP or Novell Netware®. Further in this example, one or more of personal computers 12(1)-12(n) would fulfill a server role and therefore provide the operative coupling to network 14, and hence project server 16. In yet other embodiments, however, a variety of other types of networks may couple personal computers 12(1)-12(n) together, including a WAN or any other type of network described herein or otherwise known in the art.

Network 14 couples the project server 16 to personal computers 12(1)-12(n). In this particular embodiment, network 14 comprises an intranet, although other types of networks, such as the Internet can be used.

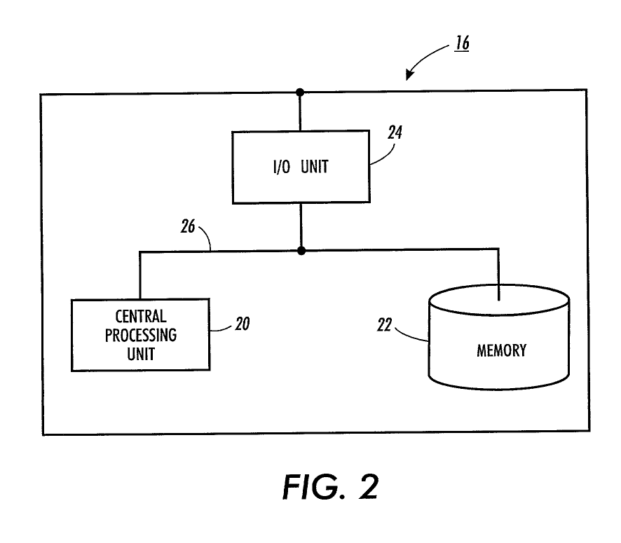

Referring to FIGS. 1 and 2, in this particular embodiment project server 16 comprises a central processing unit (“CPU”) 20, such as an Intel Pentium III processor, memory 22 and I/O unit 24, which are coupled together by a bus 26. CPU 20 executes a program of stored instructions for a method for managing a project in accordance with the present invention as described and illustrated herein. CPU 20 may also execute instructions for other tasks, including network services for providing data, memory, file directories, individual files, word processing applications, accounting applications or engineering applications.

Memory 22 may comprise any type of memory device accessible by the CPU 20, such as ferroelectric memory, read only memory (“ROM”), random access memory (“RAM”), electrically erasable programmable read only memory (“EEPROM”), erasable programmable read only memory (“EPROM”), flash memory, static random access memory (“SRAM”), dynamic random access memory (“DRAM”), ferromagnetic memory, charge coupled devices, or any other type of computer-readable mediums. In another embodiment, memory 22 may comprise a portable memory device that is used on the client side (i.e., personal computers 12(1)-12(n)). Examples of such devices include floppy-disks, hard-disks, Zip® disks, Compact Disks (“CD”), Digital Video Disks (“DVD”), computer-readable cassette tapes or reels, magnetic tapes, optical disks, smart cards or computer-readable punch cards. Further, the programmed instructions for performing one or more methods of the present invention are stored in memory 22 for execution by CPU 20. The instructions may be expressed as executable programs written in a number of computer programming languages, such as BASIC, Pascal, C, C++, C#, Java, Perl, COBOL, FORTRAN, assembly language, machine code language or any computer code or language that may be understood and performed by the CPU 20.

Project server 16 may communicate with personal computers 12(1)-12(n) through I/O unit 24. In this embodiment, I/O unit 24 may comprise a router such as any type of Ethernet® based device having sufficient ports to operatively couple project server 16 to network 14, and hence, personal computers 12(1)-12(n).

In this particular embodiment, project server 16 comprises a Microsoft IIS® Web server, although other types of systems can be used such as a WebSphere®, Apache® or Netscape® server or other types of computer systems. Project server 16 may also comprise any type of device with circuitry that is hardwired to execute instructions for performing one or more methods of the present invention as described further herein. Project server 16 executes instructions for one or more operating system environments it is operating in such as the UNIX® environment.

Referring to FIGS. 3-6, the operation of system 10 for managing a project applying time to market principles in accordance with one or more embodiments of the present invention will now be described.

Referring more specifically to FIG. 3, at step 30 the requirements for a particular project are defined and entered into project server 16 by an operator at one of the personal computers 12(1)-12(n). The requirements are entered into one or more fields provided in one or more Web pages and are stored in memory 22. The operator may access one or more Web pages sent from project server 16 through network 14 and displayed on display devices 13(1)-13(n) of personal computers 12(1)-12(n).

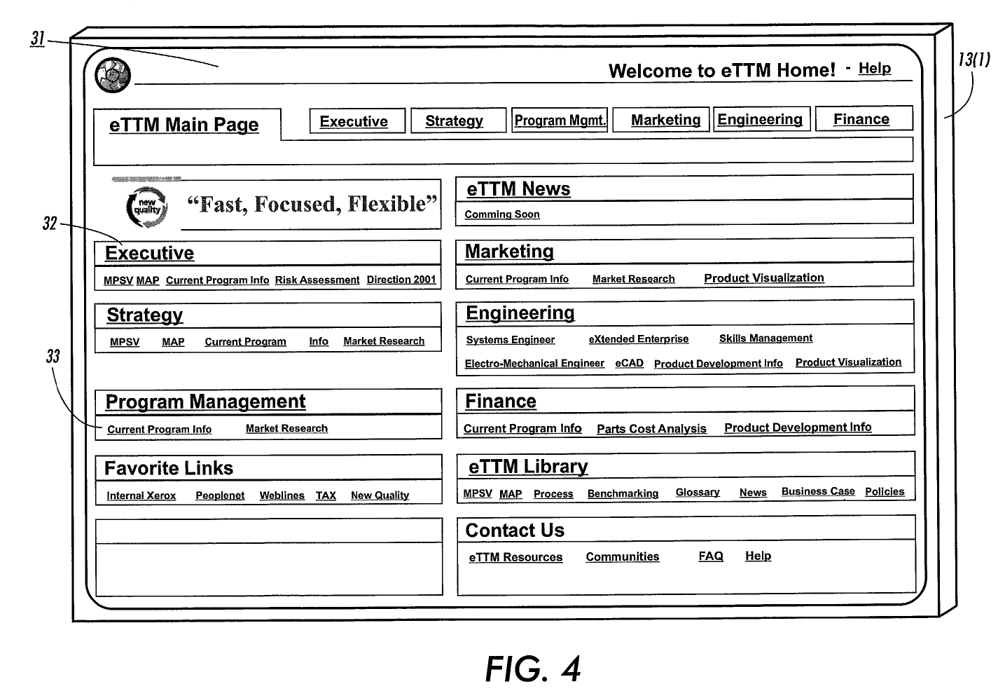

An exemplary home page 31 that may be accessed by one or more operators is illustrated in FIG. 4. In this embodiment, operators using personal computers 12(1)-12(n) may only access, view and modify particular information included in one or more Web pages provided by project server 16 depending upon their particular role in the project. For example, an operator who has an executive role in the project may access one or more of the hyperlinks shown underneath the executive heading 32, as well as any other hyperlinks shown on the home page 31, to view information that may be pertinent to an executive such as risk assessment data for the project, whereas an engineer might only be able to access one or more hyperlinks under the program management heading 33 to access market research information, for example. Moreover, when one or more hyperlinks are followed, operators may be prompted to enter a username and password to verify their role. In other embodiments, operators using personal computers 12(1)-12(n) may access, view and modify information included in one or more Web pages provided by project server 16 regardless of their particular role in the project.

Project server 16 will provide personal computers 12(1)-12(n) with as many Web pages and input fields appropriate for the particular task as needed and described further herein. Project server 16 is also programmed to be able to generate appropriate Web pages for the particular task. Project server 16 may include programming in a number of languages and implementations for generating the Web pages as needed to implement the present invention as described herein, such as Java, Javascript, Visual Basic, Perl, CGI scripts, HTML, SGML or XML.

Referring back to step 30, the project requirements are determined based on what the project is designed to accomplish and may vary for each project. The requirements may include such things as when the project needs to be completed, where the project is to take place, an expense limit and government regulations. Additionally, a quality improvement process may be defined, which will provide a systematic work process to follow for management and sub-management teams involved in the project. Typically, a customer provides the project requirements to the operator. For instance, where the project being managed is to design and manufacture a new part for a photocopier device, the project requirements may include what type of part must be designed and manufactured, specific structural requirements of the part and how soon the part must be designed, manufactured and delivered to the customer. Once the requirements and quality improvement processes are input and sent to project server 16, they are stored in memory 22 to ensure proper identification of the requirements at later phases of the project. The project requirements and quality improvement process are organized in one or more databases within memory 22. In other embodiments, the requirements may also be documented in paper form.

Next at step 40, a project strategy is defined and entered into project server 16 by an operator at one of the personal computers 12(1)-12(n). The project strategy includes preliminary defining tasks that are necessary for implementing the project such as defining supplier specifications, part dimensions and materials selection. Supplier specifications are based on the project requirements and are in terms of specifications that various vendors and/or third parties will need to meet or fulfill in order to meet the project requirements. Moreover, various positions for entities and/or individuals to assist in carrying out the project are defined as well, such as an owner, a project manager, a production manager, troubleshooting teams and engineering teams.

Next, in step 50 an overall time schedule based on the project requirements for the project strategy is defined and entered into project server 16 by an operator at one of the personal computers 12(1)-12(n). The time schedule is divided into time periods for completing the project. Further, the time schedule is keyed to a timeline that is projected out to meet a proposed deadline, which may be set forth in the project requirements. In other embodiments, a number of types of time schedules are defined, such as critical path analyses, milestone charts, equipment/facility/construction/quality control/commissioning, PERT charts, GANTT Schedules and travel schedules/charts.

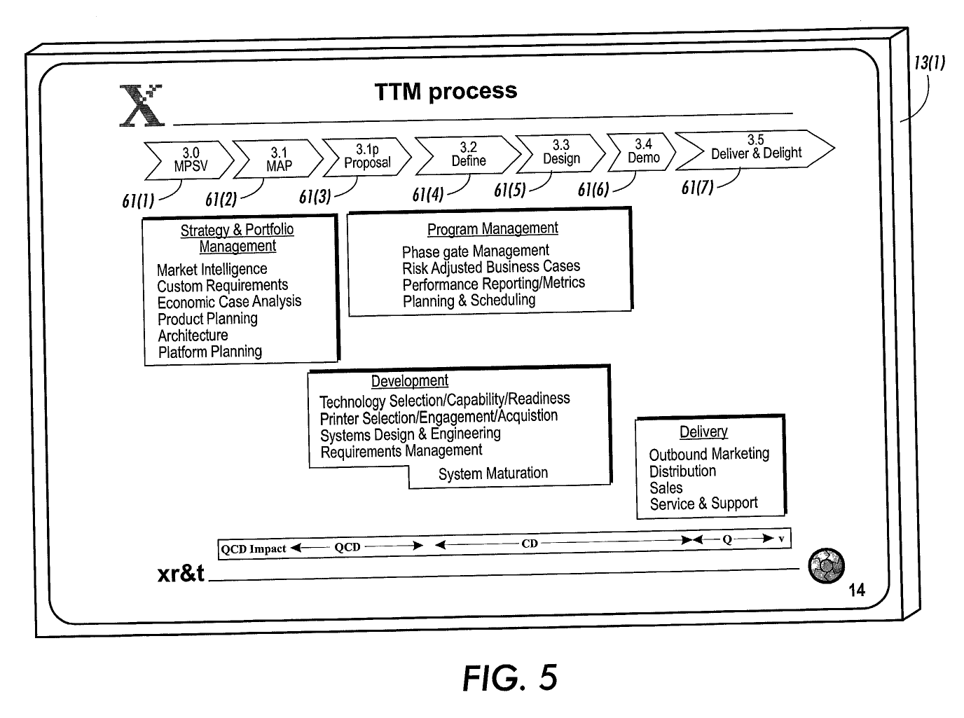

Next, in step 60 project phases are defined and entered into project server 16 by an operator at one of the personal computers 12(1)-12(n). The project phases are stored in memory 22 to be used for the current project, and may be used as templates for other projects as will be described further herein below. In this embodiment, the phases are based on a time to market process and comprise stages of a project that must be completed before a project may advance to a next stage as discussed further herein. Moreover, each phase includes activities that must be performed to satisfy exit criteria before advancing to the next phase of the project. The phases in this embodiment include a project strategy/plan definition phase, project definition phase, project design phase, project demonstration phase, project delivery phase and project implementation phase. Project phases may be added and deleted as necessary or as particular circumstances require. An exemplary Web page showing a set of project phases 61(1)-61(7) on one of the display devices 13(1)-13(n) is shown in FIG. 5.

Referring back to FIG. 3, in step 70 project server 16 integrates the defined project phases with the time schedule defined in step 50 to create an overlay. The phases are integrated with the time schedule by associating each phase with a corresponding time period of the time schedule. The overlay is sent by project server 16 to one of personal computers 12(1)-12(n) so it can be displayed on one of display devices 13(1)-13(n), respectively, when desired by an operator.

Next at step 80, the project is carried out according to the time schedule defined in step 50 by implementing the identified activities in each project phase and satisfying the exit criteria mentioned above at step 60. In this particular embodiment, the persons responsible for implementing the activities are identified in the project requirements at step 30, although they could be identified at other times, such as during steps 40 or 60.

As the project phases are implemented, the exit criteria for each phase are satisfied before a subsequent phase can be implemented. The exit criteria are considered satisfied by completing the activities associated with the exit criteria.

If an activity is not completed within a predetermined time period a determination is made of whether an exception should be made to consider the exit criteria satisfied despite the non-completion. The predetermined time period depends upon the type of project and may be any amount of time agreed upon by one or more of the project participants or using historical stored information associated with past projects.

Moreover, the exceptions may be either for individual activities or for individual exit criteria. The exceptions may be beneficial for achieving the project objectives in a timely and efficient manner. For instance, it may be impossible or difficult to implement subsequent project phases until the current phase being considered for an exception is completed.

The decision of whether to make an exception may be based upon whether advancing the project to the next phase would create a level of risk that exceeds a threshold risk level in terms of meeting the project objectives. In this embodiment, persons such as executives or other administrators may make an exception by accessing project server 16 using one of the personal computers 12(1)-12(n) and entering the appropriate information and/or comments in one or more fields included in a Web page provided by project server 16 to alert others involved in the project that an exception has been made. Thereafter, operators or other persons associated with the project at one of the personal computers 12(1)-12(n) may access and view information regarding the project through one or more Web pages provided by project server 16, where the project is shown to have advanced from one phase to the next as a result of an exception being made.

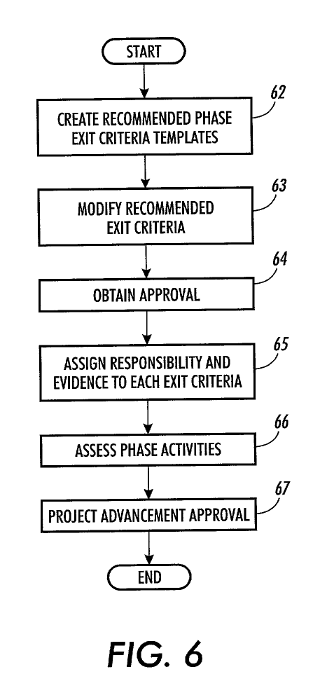

Referring now to FIG. 6, the operation of system 10 for using project phases and exit criteria templates to manage a project in accordance with the present invention will now be described. In particular, steps 62-67 further describe step 60 described earlier with reference to FIG. 3.

At step 62, recommended project exit criteria may be defined for each of the project phases described above and entered into project server 16 by an operator at one of the personal computers 12(1)-12(n) to create exit criteria templates for a project. In other embodiments, the recommended project exit criteria may have already been created and stored in project server 16, as described further herein. In either case, the exit criteria templates are stored in memory 22 of project server 16. Exit criteria are defined for each of the project phases and entered into project server 16 by an operator at one of the personal computers 12(1)-12(n). The project exit criteria are goals that need to be satisfied before the project can advance to the next phase. The exit criteria may vary for each project phase, and may include corporate knowledge gleaned from current and past projects such as benchmark testing based on other completed projects, financial revenues, project cost economics or technology readiness demonstrated. The corporate knowledge is saved in one or more databases within memory 22 of project server 16.

Activities for each of the exit criteria are identified and entered into project server 16 by an operator at one of the personal computers 12(1)-12(n). The activities are the individual tasks that need to be completed to satisfy each of the exit criteria defined for each project phase. The activities will vary for each exit criterion, and may include defining the product requirements, developing the product design strategy, completing corporate funding request documents, completing a manufacturing assessment report and ensuring compliance with safety regulations. In this embodiment, as discussed above, operators of system 10 may initially set up the exit criteria templates for a project with generic exit criteria stored therein. Moreover, when initially entering the information into project server 16 for a project, an operator at one of the personal computers 12(1)-12(n) may select the appropriate recommended exit criteria for each phase of the project from a list of exit criteria templates displayed on a Web page provided by project server 16. The exit criteria are keyed to each type of phase and for particular types of projects.

For instance, an operator selects from a Web page a particular type of project, such as manufacturing a photocopier device part. This causes the project server 16 to provide to the requesting one of personal computers 12(1)-12(n) one or more Web pages displaying at least one exit criteria available for each of the phases defined for the project in step 60 shown in FIG. 3, which in this example is a photocopier device. Again, if no such template exists, the operator may perform the procedures described above to create new templates.

Next, at step 63, the recommended project exit criteria defined in step 62 may be modified and entered into project server 16 by an operator at one of the personal computers 12(1)-12(n) to account for the requirements of a particular project.

Next at step 64, the modified exit criteria are reviewed and approved as required by the appropriate persons by using personal computers 12(1)-12(n) to access one or more Web pages provided by project server 16. In this particular embodiment, one or more of the modified exit criteria may require the approval of one or more persons involved in the project before it is incorporated into the project. In other embodiments, none of the established exit criteria will require approval before being incorporated into the project.

Next, at step 65 certain operators are identified as being responsible for ensuring that the activities are properly completed. Operators at one or more of the personal computers 12(1)-12(n) may access information organized in a work process database stored in memory 22 of project server 16 to determine which persons should be assigned roles for completing the activities within a project phase. Moreover, evidence may be associated with the exit criteria and be made accessible to the operators accessing project server 16 using one of personal computers 12(1)-12(n).

For instance, a senior engineer, who according to the approved exit criteria for the design phase of a photocopier device part manufacturing project must inspect the part blueprints and sign them, could scan the signed prints and upload them to project server 16 once that person has signed the document. The blueprint would be stored in memory 22 of project server 16. Moreover, one or more standard output templates could be created for a number of types of evidence such as scanned documents or Internet Web pages, and be organized into a standard output database in memory 22. Further in this example, the senior engineer would be able to indicate by entering information in the appropriate fields included in a Web page provided by project server 16 that the particular exit criterion had been satisfied.

Next at step 66, the progress of activities occurring within a program phase can be monitored and assessed by operators at one or more of the personal computers 12(1)-12(n) by accessing one or more Web pages provided by project server 16. Thus, the operators could determine by accessing the Web pages that a senior engineer, for example, was responsible for satisfying a particular exit criterion and indeed satisfied the exit criterion. Additionally, the operators may view evidence of such as explained above in step 65. Further, problems and risks may be identified and tracked.

Operators at one or more of the personal computers 12(1)-12(n) may consult assessment matrices using a quality solving process to assess a particular problem for a project to identify and track any problems or risks as they develop for a project within a project phase. The assessment matrices would be accessible through one or more Web pages provided by project server 16. Thereafter, the operators may develop action plans to deal with the noted problems or risks. Other persons involved in the project would be able to check the status of the problem by accessing one or more Web pages.

Next at step 67, a project and peer assessment team using one or more of the personal computers 12(1)-12(n) determine whether the exit criteria for the phase have been satisfied. The evidence, risks and problems described above are assessed to determine whether the project can be advanced to the next phase with minimal risk. Once the project and peer assessment teams have made their final assessment, using the one or more personal computers 12(1)-12(n) they may enter their assessment information in appropriate fields included in one or more Web pages provided by project server 16. Thereafter, a decision team may review their assessment information and provide a final approval by entering the information in appropriate fields included in one or more Web pages provided by project server 16.

Other modifications of the present invention may occur to those skilled in the art subsequent to a review of the present application, and these modifications, including equivalents thereof, are intended to be included within the scope of the present invention. Further, the recited order of processing elements or sequences, or the use of numbers, letters, or other designations therefor, is not intended to limit the claimed processes to any order except as may be specified in the claims.

What is claimed is:

1. A method for managing a project, the method comprising:
creating at least one phase for the project;
identifying which of one or more stored exit criteria are applicable to at least one of the phases of the project;
establishing the identified one or more stored exit criteria for the at least one phase, the one or more exit criteria based at least partially on experience gained from one or more prior projects;
determining whether each of the identified one or more stored exit criteria have been satisfied for the at least one phase; and
enabling the project to advance to a next one of the phases based on the determination of whether each of the identified one or more stored exit criteria have been satisfied for the at least one phase.

2. The method as set forth in claim 1 further comprising modifying one or more of the identified one or more stored exit criteria to accommodate for project requirements.

3. The method as set forth in claim 1 wherein the enabling further comprises enabling the project to advance if the determination indicates that at least one of the identified one or more exit criteria have been satisfied.

4. The method as set forth in claim 1 further comprising tracking one or more problems noted for the project.

5. The method as set forth in claim 1 wherein the determining whether each of the identified one or more stored exit criteria have been satisfied for the at least one phase further comprises:
monitoring progress of portions of the at least one phase of the project related to the identified one or more stored exit criteria; and
determining if the portions related to the identified one or more stored exit criteria have been performed, wherein the enabling is also based on the determining if the portions related to the identified one or more stored exit criteria have been performed.

6. The method as set forth in claim 1 further comprising making information regarding the project accessible through at least one Web page provided to one or more project participants, the information being accessible to each of the project participants depending upon their role in the project.

7. A project management system comprising:
an interface system that creates at least one phase for the project;
an identification system that identifies which of one or more stored exit criteria are applicable to at least one of the phases of the project;
a phase establishing system that establishes the identified one or more stored exit criteria for the at least one phase, the one or more exit criteria based at least partially on experience gained from one or more prior projects;
a determination system that determines whether each of the identified one or more stored exit criteria have been satisfied for the at least one phase; and
an advancement system that enables the project to advance to a next one of the phases based on the determination of whether each of the identified one or more stored exit criteria have been satisfied for the at least one phase.

8. The system as set forth in claim 7 wherein the interface system modifies one or more of the identified one or more stored exit criteria to accommodate for project requirements.

9. The system as set forth in claim 7 wherein the advancement system enables the project to advance if the determination indicates that at least one of the identified one or more exit criteria have been satisfied.

10. The system as set forth in claim 7 further comprising a problem tracking system that tracks one or more problems noted for the project.

11. The system as set forth in claim 7 wherein the determination system monitors progress of portions of the at least one phase of the project related to the identified one or more stored exit criteria, and determines if the portions related to the identified one or more stored exit criteria have been performed, wherein the advancement system enables the project to advance based on the determining if the portions related to the identified one or more stored exit criteria have been performed.

12. The system as set forth in claim 7 wherein the interface system makes information regarding the project accessible through at least one Web page provided to one or more project participants, the information being accessible to each of the project participants depending upon their role in the project.

13. A computer readable medium having stored thereon instructions for managing a project which when executed by one or more processors, causes the processors to perform:
creating at least one phase for the project;
identifying which of one or more stored exit criteria are applicable to at least one of the phases of the project;
establishing the identified one or more stored exit criteria for the at least one phase;
determining whether each of the identified one or more stored exit criteria have been satisfied for the at least one phase; and
enabling the project to advance to a next one of the phases based on the determination of whether each of the identified one or more stored exit criteria have been satisfied for the at least one phase.

14. The medium as set forth in claim 13 further comprising modifying one or more of the identified one or more stored exit criteria to accommodate for project requirements.

15. The medium as set forth in claim 13 wherein the enabling further comprises enabling the project to advance if the determination indicates that at least one of the identified one or more exit criteria have been satisfied.

16. The medium as set forth in claim 13 wherein the determining further comprises tracking one or more problems noted for the project.

17. The medium as set forth in claim 13 wherein the determining whether each of the identified one or more stored exit criteria have been satisfied for the at least one phase further comprises:
monitoring progress of portions of the at least one phase of the project related to the identified one or more stored exit criteria; and
determining if the portions related to the identified one or more stored exit criteria have been performed, wherein the enabling is also based on the determining if the portions related to the identified one or more stored exit criteria have been performed.

18. The medium as set forth in claim 13 further comprising making information regarding the project accessible through at least one Web page provided to one or more project participants, the information being accessible to each of the project participants depending upon their role in the project.

19. A method for managing a project, the method comprising:
identifying one or more project requirements;
creating a project strategy;
defining a time schedule based upon the project strategy;
identifying and creating one or more project phases within the project;
integrating the one or more phases with the time schedule;
identifying which of one or more stored exit criteria are applicable to at least one of the phases of the project;
establishing the identified one or more stored exit criteria for the at least one phase;
determining whether each of the identified one or more stored exit criteria have been satisfied for the at least one phase; and
implementing the project by enabling the project to advance to a next one of the phases based on the determination of whether each of the identified one or more stored exit criteria have been satisfied for the at least one phase.

20. The method as set forth in claim 19 further comprising basing the one or more exit criteria at least partially on experience gained from one or more prior projects.

21. The method as set forth in claim 19 further comprising tracking one or more problems noted for the project.

22. The method as set forth in claim 19 further comprising making information regarding the project accessible through at least one Web page provided to one or more project participants, the information being accessible to each of the project participants depending upon their role in the project.

23. A project management system comprising:
a project requirements system that identifies one or more project requirements;
a strategy creation system that creates a project strategy;
a time schedule system that defines a time schedule based upon the project strategy;
a project phase system that identifies and creates one or more phases within the project;
a project integration system that integrates the one or more phases with the time schedule;
a project identification system that identifies which of one or more stored exit criteria are applicable to at least one of the phases of the project;
a phase establishing system that establishes the identified one or more stored exit criteria for the at least one phase;
a determination system that determines whether each of the identified one or more stored exit criteria have been satisfied for the at least one phase; and
a project implementation system that implements the project by enabling the project to advance to a next one of the phases based on the determination of whether each of the identified one or more stored exit criteria have been satisfied for the at least one phase.

24. The system as set forth in claim 23 wherein the phase establishing system bases the one or more exit criteria on experience gained from one or more prior projects.

25. The system as set forth in claim 23 further comprising a tracking system that tracks one or more problems noted for the project.

26. The system as set forth in claim 23 wherein the interface system makes information regarding the project accessible through at least one Web page provided to one or more project participants, the information being accessible to each of the project participants depending upon their role in the project.

27. A computer readable medium having stored thereon instructions for managing a project which when executed by one or more processors, causes the processors to perform:
identifying one or more project requirements;
creating a project strategy;
defining a time schedule based upon the project strategy;
identifying and creating one or more project phases within the project;
integrating the one or more phases with the time schedule;
identifying which of one or more stored exit criteria are applicable to at least one of the phases of the project;
establishing the identified one or more stored exit criteria for the at least one phase;
determining whether each of the identified one or more stored exit criteria have been satisfied for the at least one phase; and
implementing the project by enabling the project to advance to a next one of the phases based on the determination of whether each of the identified one or more stored exit criteria have been satisfied for the at least one phase.

28. The medium as set forth in claim 27 further comprising basing the one or more exit criteria at least partially on experience gained from one or more prior projects.

29. The medium as set forth in claim 27 further comprising tracking one or more problems noted for the project.

30. The medium as set forth in claim 27 further comprising making information regarding the project accessible through at least one Web page provided to one or more project participants, the information being accessible to each of the project participants depending upon their role in the project.
